(19) United States
(12) Patent Application Publication
(10) Pub. No.: US 2007/0150437 A1
(43) Pub. Date: Jun. 28, 2007

(54) Protection against timing and resource consumption attacks

(75) Inventors: Cynthia Dwork, San Francisco, CA (US); Frank D. McSherry, San Francisco, CA (US); Ilya Mironov, Mountain View, CA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/316,761

(22) Filed: Dec. 22, 2005

(51) Int. Cl. G06F 17/30

(52) U.S. Cl. 707/2

(57) ABSTRACT

Systems and methods are provided for obscuring an amount of a resource used to process an item. In general, contemplated techniques comprise assigning a maximum allowable amount of the resource for processing a sub-part of the item. If the maximum allowable amount of the resource is reached, processing the sub-part may be terminated. Once all sub-parts are processed, a noisy quantity of the resource that was consumed in processing the item may be released. The noisy quantity is determined by adding a positive amount of the resource, combined with a noise value, to an actual quantity of the resource that was consumed.

### BACKGROUND

A timing attack is an example of a resource consumption attack. In a timing attack, information is gleaned by the amount of time it takes a computer to process a query. For example, consider a computer that asks a user to log in before the user is allowed to access private documents. The user enters a username and password, and the computer checks them against a stored usemame and password.

One method for checking the username and password is to first check whether the first letter of the username is correct. If it is, the computer may proceed to check whether the second letter is correct. If the first letter of the username is not correct, the computer may stop the operation and notify the user that the username and/or password were incorrect.

An attacker may employ a timing attack in this setting to gain access to the true user's private documents. The attacker knows that if the first letter of an entered username is incorrect, the computer will take some very short amount of time to respond with an “access denied” message. However, if the first letter is correct, the computer will take slightly longer to respond. The attacker can go through the letters of the alphabet, and find which ones cause the computer to take extra time to respond. The same approach may then be used to discover the letters of the password.

Another resource consumption attack can be made to discover private data that may be stored in a database. For example, if certain data takes more of a resource, e.g. time or electric power, to process than other data, an attacker can find out whether such high-consumption data is present in a dataset that is queried.

In the case of timing attacks on databases, one solution has been to ensure that every query takes exactly n time to process, where n is the number of rows in a database. This solution is inelegant for a number of reasons. For example, if the predetermined query time is high, it can add too much time to every query. If the predetermined time is low, it can result in too many failures. For these and other reasons, the computing industry as well as consumers and other industries that may be subject to resource consumption attacks are in need of better techniques for obscuring resource consumption used when processing items.

### SUMMARY

In consideration of the above-identified shortcomings of the art, the present invention provides systems and methods for obscuring an amount of a resource, for example, an amount of time, used to process an item, for example, a database query. In general, contemplated techniques comprise assigning a maximum allowable amount of the resource for processing a sub-part of the item. In the time/database query setting, a subpart of the database query is a database row. If the maximum allowable amount of the resource is reached, processing the sub-part may be terminated. Once all sub-parts are processed, a noisy quantity of the resource that was consumed in processing the item may be released. The noisy quantity is determined by adding a positive amount of the resource, combined with a noise value, to an actual quantity of the resource that was consumed. Other advantages and features of the invention are described below.

### BRIEF DESCRIPTION OF THE DRAWINGS

The systems and methods for protection against timing and resource consumption attacks in accordance with the present invention are further described with reference to the accompanying drawings in which:

FIG. 1 illustrates a method for obscuring an amount of a resource consumed.

FIG. 2 illustrates adding a positive amount of a resource, combined with a noise value, to an amount of a resource consumed.

FIG. 3 illustrates terminating processing of a sub-part if such processing consumes a maximum allowable amount of the resource.

FIG. 4 illustrates a method for selecting a noise value.

FIG. 5A illustrates an exponential noise distribution.

FIG. 5B illustrates a normal noise distribution.

FIG. 5C illustrates a hybrid noise distribution.

FIG. 6 illustrates a method for determining a positive amount of a resource.

FIG. 7 illustrates releasing a noisy quantity of the resource that was consumed.

FIG. 8 illustrates an embodiment in which a response to a database query is released at a time determined by the techniques described herein.

FIG. 9 illustrates a system configured to obscure an amount of a resource consumed.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

The invention generally contemplates the use of noise to obscure resource consumption. The concept of adding noise in other contexts is discussed in U.S. patent application No. 11/244,800, filed Oct. 6, 2005 (attorney docket no. MSFT 5434/314792.01); U.S. patent application Ser. No. ______, filed Dec. 9, 2005 (attorney docket no. MSFT 5430/314795.01); U.S. patent application Ser. No. ______, filed Dec. 2, 2005 (attorney docket no. MSFT-5428/314794.01); U.S. patent application Ser. No. ______ (attorney docket no. MSFT 5432/314796.01); U.S. patent application Ser. No. ______, filed Nov. 30, 2005 (attorney docket no. MSFT 5425/314793.01); and U.S. patent application No. ______ (attorney docket no. MSFT 5429/314797.01). The above references are hereby incorporated by reference in their entirety.

Additional materials related to privacy preservation, including so-called secure function evaluation and other techniques, is available in the following references: Ben-Or, Goldwasser, and Wigderson, “Completeness Theorems for Non-Cryptographic Fault-Tolerant Distributed Computation” (1988); Goldreich, Micali, and Wigderson, “How to Play Any Mental Game” (1987); Chawla, Dwork, McSherry, Smith, and Wee, “Toward Privacy in Public Databases,” Theory of Cryptography Conference, 2005; Dwork, Nissim, “Privacy-Preserving Data Mining in Vertically Partitioned Databases,” Crypto 2004; Blum, Dwork, McSherry, Nissim, “Practical Privacy: The SULQ Framework,” PODS 2005; and Chawla, Dwork, McSherry, Talwar, “On the Utility of Privacy-Preserving Histograms,” UAI 2005.

Dwork and Nissim 2004 and Blum, Dwork, McSherry, and Nissim 2005 show a method for preserving privacy in an interactive statistical database. The database comprises of a number of independent “rows”. Rows may contain anything: pictures, strings, sexual histories, medical records, etc. For the purpose of this specification, it is acknowledged that databases may be organized in a wide variety of ways, and may be N dimensional. Thus, the term “row” should be understood to comprise a column, row, or any other N dimensional correlation of data.

In the simplest form, query is a function that maps a row to a real number in the range [0,1]. We define the quantity obtained by applying the query function to each row and summing the results to be the “true answer”. The privacy-preserving database mechanism, denoted “K” in honor of Alfred Kinsey, adds a certain type of noise to the true answer, and releases this noisy value. Three privacy-preserving distributions on noise were discussed in Dwork and Nissim 2004 and Blum, Dwork, McSherry, and Nissim 2005. In particular, in Blum, Dwork, McSherry, and Nissim 2005 it is shown that the amount of noise necessary for privacy depends only on the total number of queries to which any row in the database is exposed (in the presentation above, this is just the total number of queries to which the database responds, in its lifetime). We denote this bound T.

The techniques referenced above can also be used to defend against resource consumption attacks. In the case of timing attacks, these are attacks that exploit the fact that different operations, e.g., a shift operation and a multiply operation, require different amounts of real time to carry out on a processor. In the context of cryptography, and exponentiation in particular, a shift corresponds to a zero bit in an exponent, while a multiply (+a shift) corresponds to a one bit; thus, detecting the difference in time required can be used to discover the secret exponent in, say, a Rivest, Shamir, and Adleman (“RSA”) decryption.

In one embodiment, a resource consumption attack would be a function that under certain circumstances, for example when a row matches a profile of a “target” person, whose privacy the attacker wishes to compromise, takes extra time to evaluate if confidential data in the row has certain content. For example an attack might specify a victim, and cause a query to take additional time to process if the victim is HIV positive.

Let the attacker's potentially malicious query function be denoted f′. We defend against this attack by viewing the time taken to evaluate the function f′ on a given row as a new query function, f, where:
f(row i)=time taken to evaluate f′0 on row i, for any row i in the database.

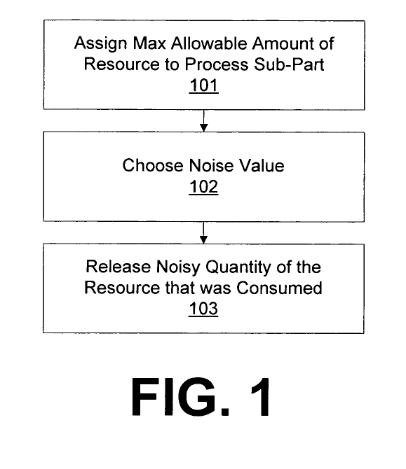

We then proceed with the following method, illustrated in FIG. 1, which may be implemented as a set of computer executable instructions:

1. Assign a maximum allowable amount of resources for the evaluation of any item sub-part 101, after which the processing will be terminated. In the case of the timing attack, this comprises assigning a maximum allowable time for the evaluation of any row, after which the computation will be terminated. We call this maximum allowable time a single unit of time, so that the time taken to evaluate a given row is a number between 0 and 1 time units.

2. Choose a random noise value $N$ 102. The random noise value may be chosen according to the “K” algorithm as described in the above referenced publications. It may also be chosen by any other acceptable method. The noise value will be either a positive or negative number.

3. Release a noisy quantity of the resource that was consumed 103. In the case of time, releasing a noisy quantity of the resource consumed comprises waiting for a period, determined at least in part by the noise value, prior to releasing a query response. The response to a query can be released substantially $\sum_i f(row i)+D+N$ time units after the query issued. Here D is a fixed positive amount of the resource. It can depend on the size of the database, or the number or rows processed in the query, but in preferred embodiments remains independent of the data in the rows of the database. It is chosen to be sufficiently large that, with overwhelming probability over the randomness in the noise generation procedure, $|N|<D$.

Since this technique preserves resource consumption information independent of the size of the database, it can also be used to protect, for example, the steps in the evaluation of an exponentiation to a secret exponent. The length of the exponent corresponds to the size of the database. The size of the database is typically not secret. A time unit is the time to carry out the more expensive operation (multiply+shift). Note that in a cryptographic setting we may require stronger security than in the privacy setting, because the utility requirements of the privacy setting mandate the relaxation. Increased security can be accomplished by changing the parameters when computing the noise.

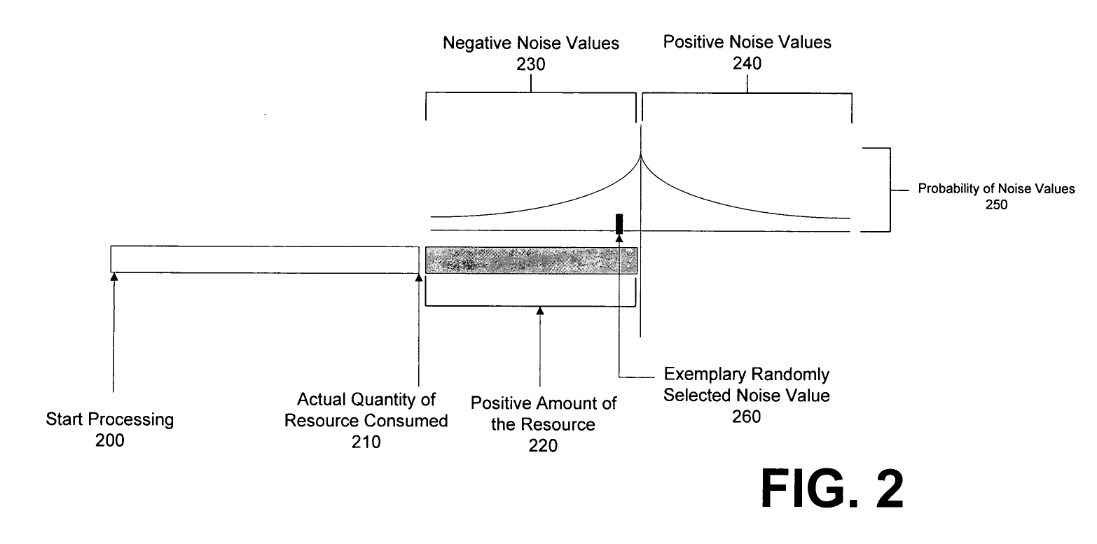

FIG. 2 illustrates a schematic view of an exemplary technique for obscuring an amount of a resource that was consumed. FIG. 2 will be discussed using time on a computer processor as an exemplary resource, however it should be understood that the same technique may be applied in the context of other resources.

Time consumption begins when processing an item begins at 200. Time consumption due to processing the item ends at 210. Time consumption may end at 210 because processing the item is complete, or may end for some other reason, e.g. due to meeting or exceeding a time limit for processing a particular sub-part. However, a processor response is not returned at time 210. An additional amount of the resource—here, time—is consumed prior to returning the response.

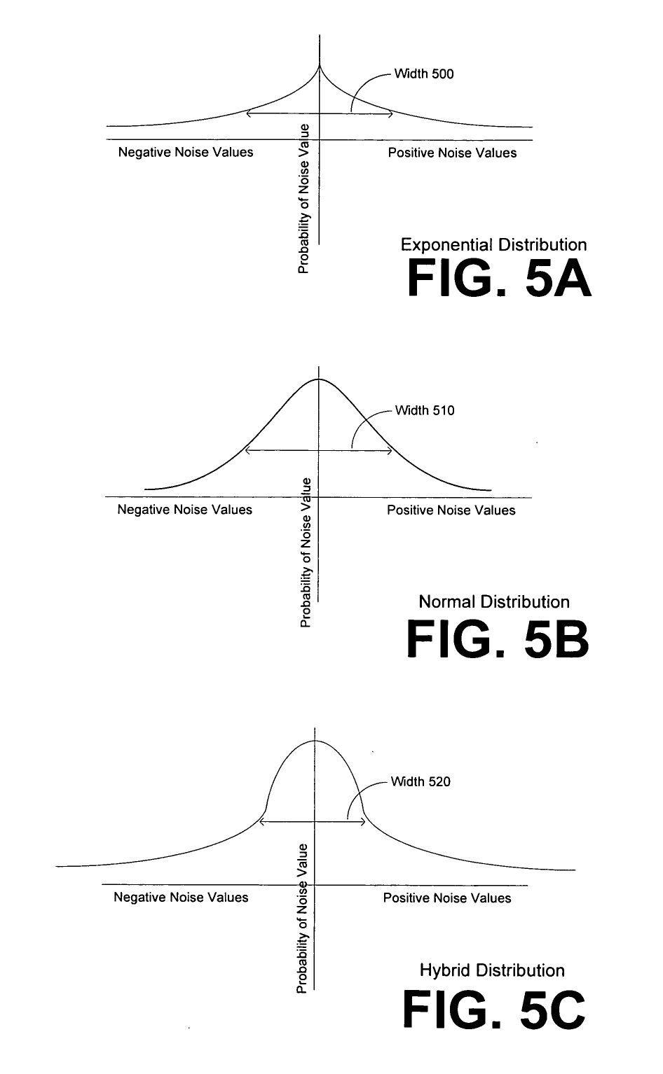

The amount of additional time consumed is determined by the positive amount of time 220 combined with a noise value 260. The noise value is randomly selected from a distribution of noise values. An exemplary distribution is superimposed on FIG. 2, and is further explained in connection with FIGS. 5A-5C. In general, the distribution of noise values provides a probability of noise values 260, and both positive noise values 240 and negative noise values 230 may be randomly selected from the distribution.

In FIG. 2, an exemplary noise value 260 was selected, which happened to be a negative noise value. Thus, the positive amount of time 220 is reduced by the negative noise value 260, and the processor response is released at a time determined by this combination of the positive amount of time 220 and the negative noise value 260.

When time is the resource, as in this example, it will generally be advantageous to actually consume the additional time prior to releasing a response. In various embodiments, however, the additional quantity of the resource need not actually be consumed, so long as the released information about resource consumption is obscured using the techniques herein. For example, in the case of electrical power consumption, embodiments may actually consume some additional power, thereby obscuring the amount of power used, or may simply alter the information that is released about power consumption, without actually consuming the extra power, or for example by putting the additional electrical power to other uses.

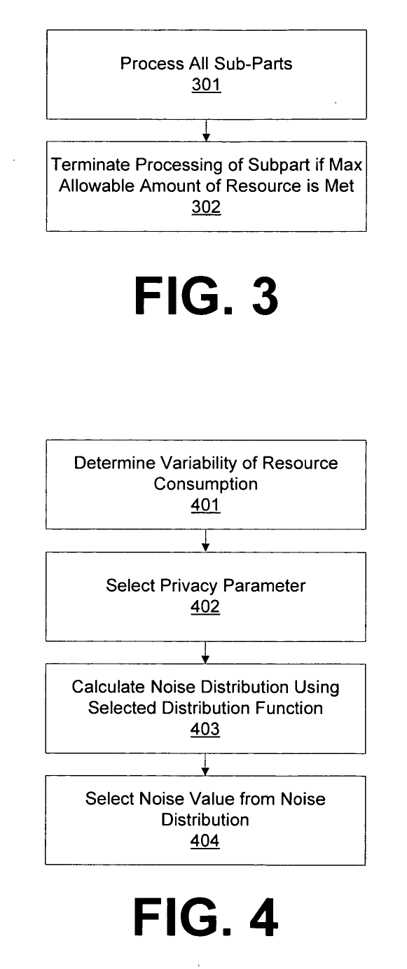

FIG. 3 illustrates a method for processing an item where there is a max allowable amount of a resource that may be used in processing any item sub-part. Here, a database query is an exemplary item. A query is a function applied to a plurality of rows in a database. Thus, a query subpart comprises the application of the query to a row in a database. The query may be executed by processing all rows to which the query is directed 301. One row is processed, then the next, and so forth until all rows are processed. If processing any row meets the max allowable resource consumption, e.g. time or electrical power, then the processing of that row may be terminated 302. Termination of processing the row may comprise terminating the entire query, or may comprise simply moving on to the next row, as needed for the particular circumstances.

The selected value of the max allowable amount of resource for processing a sub-part is determined on a case-by case basis. In general, this value is selected to allow for some variability in resource consumption, as it may occasionally take additional resources to process a sub-part, and it would be inefficient to terminate processing too often, simply because some additional resources are consumed. However, the max allowable amount of resource should be sufficiently restrictive to prevent significant resource consumption beyond the likely consumption associated with other sub-parts.

The question of how large the positive amount of a resource should be, and what noise distribution should be used, may be satisfied on a case-by-case basis depending upon the circumstances. FIGS. 4, 5A-5C, and 6 are generally directed to providing exemplary techniques for determining appropriate quantities. These figures provide general techniques and examples that will be implementable by those of skill in the art in the various fields to which the invention may be applied.

FIG. 4 illustrates a method for determining an appropriate noise distribution, and selecting a noise value. First, the variability of resource consumption associated with processing of the sub-parts may be determined 401. High variability will require wider noise distributions, and corresponding higher likelihood of large noise values. The larger noise values will obscure the presence of sub-parts that may require more resource consumption.

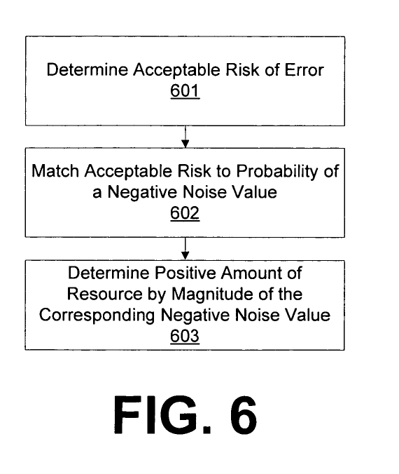

Next, a privacy parameter may be selected 401. The privacy parameter allows adjustment of a noise distribution to fit the privacy needs of a particular situation. If very little privacy loss is tolerable, the privacy parameter may be selected to cause a wider noise distribution, therefore better obscuring resource consumption. If privacy loss is less of a concern, the privacy parameter may be selected to cause a narrower noise distribution, resulting in less obscurity but also less additional resource consumption. As will be explained with reference to FIG. 6, the width of a noise distribution may, in some embodiments, be related to the positive amount of the resource.

Next, a noise distribution may be calculated using a selected noise distribution function 403. Exemplary noise distributions are the “exponential” distribution, depicted in FIG. 5A, the so-called “normal” distribution of FIG. 5B, and the hybrid normal/exponential distribution of FIG. 5C. These distributions are exemplary only and any distribution function may be used, although there are features of the illustrated distributions that are considered advantageous. First, the illustrated distributions are centered on zero, making zero the noise value of highest probability. Second, the noise distributions provide decreasing probability as noise values become large in the positive and the negative direction.

Returning to FIG. 4, the final step 404 is selecting a noise value from the distribution. The noise value is preferably selected randomly from a selection of noise values that is distributed according to the calculated noise distribution, such as those of FIGS. 5A-5C.

FIG. 5A-5C depict noise values along an x-axis, and probabilities associated with such noise values on the y-axis. Thus, a noise value on the x-axis corresponding to a high value on the y-axis has a high probability of being selected.

FIG. 5A illustrates a symmetric exponential density distribution, or “exponential distribution,” as will be recognized by those of skill in mathematics. FIG. 5B illustrates a normal distribution. FIG. 5C represents a hybrid distribution. The hybrid distribution of FIG. 2C is a normal and exponential distribution, such that a normal distribution defines a portion of the distribution comprising the most probable noise values, i.e. those with a higher y-axis value, and an exponential distribution defines a portion of the distribution comprising the least probable noise values, i.e. those with low y-axis values, corresponding to larger absolute values on the x-axis.

Variability in resource consumption and a privacy parameter can be used in calculating width of each of the distributions in FIG. 5A-5C. Noise distribution width is indicated in FIGS. 5A-5C by 500, 510 and 520 respectively. An infinite number of small modifications to the distributions depicted in FIG. 5A-5C are possible, as will be appreciated by those of skill in mathematics.

An exemplary noise distribution equation for a distribution such as that of FIG. 5A is:
noise˜exp(−\epsilon∥x∥/V)

An exemplary noise distribution equation for a distribution such as that of FIG. 5A is:
noise˜exp(−\epsilon∥x∥ˆ2/V)

Where \epsilon is the privacy parameter, and ∥x∥ is an L1 norm. The mathematical definition of an L1 norm is the sum of absolute values of entries in a vector of values. Thus, for a vector x of n coordinates x1, x2, x3, . . . xn, the L1 norm ∥x∥=\sum_{—}{1\le I\le n}|xi|. V is a measure of variability of resource consumption associated with processing of the sub-parts of an item. Further distributions such as that of FIG. 5C may be constructed by those of skill in mathematics.

Here, the variability in resource consumption, V, is directly analogous to query diameter presented in U.S. Patent Application No. ______, filed ______ (attorney docket no. 314793.01/MSFT 5425), or change in the value of the output function. Thus, V can be determined using diameter techniques if desired. That is, V may be determined by taking the largest possible change in resources that a single element could induce on the entire computation. Note that it is only in these settings that there is a need to use norms ∥x∥, since in the “one dimensional” case they are just the absolute value.

FIG. 6 illustrates an exemplary acceptable method for determining a positive amount of a resource. In the method of FIG. 6, the positive amount of a resource is determined based on a calculated noise distribution and an acceptable point at which the negative noise values may be truncated. As explained above, the positive amount of a resource may be chosen to be sufficiently large that, with overwhelming probability over the randomness in the noise generation procedure, $|N|<D$. Thus, there is a sufficiently small probability that the randomly selected noise value will be a negative noise value that is of greater absolute value than the selected positive amount of the resource. When such a negative noise value is selected, the noise value may be adjusted to be equal in size to the positive amount of the resource, so that the noisy quantity equals the actual amount of the resource consumed.

Therefore, with reference to FIG. 6, first an acceptable risk of error may be determined 601. Here, “error” is the risk that a negative noise value will exceed the positive amount of the resource. Next, the acceptable risk may be matched to a probability of a negative noise value 602. The corresponding negative noise value will depend on the distribution equation that is used. Finally, the positive amount of a resource may be set to the absolute value of the selected negative noise value 603.

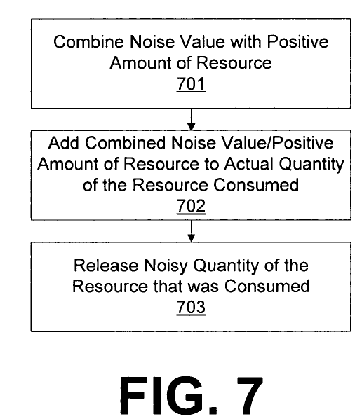

FIG. 7 illustrates a method for releasing a noisy quantity of a resource. The method of FIG. 7 may typically be carried out after a positive amount of the resource and noise distribution is selected, and after the processing of the item as illustrated in FIG. 3 is completed. A noise value randomly selected from a noise distribution is combined with the determined positive amount of the resource 701, thereby generating a first noisy quantity of the resource. Next, the first noisy quantity of the resource is combined with the actual amount of the resource consumed when processing the item 702, thereby generating a second noisy quantity of the resource. Finally, the second noisy quantity of the resource—referred to herein generically as a noisy quantity of the resource—is released 703.

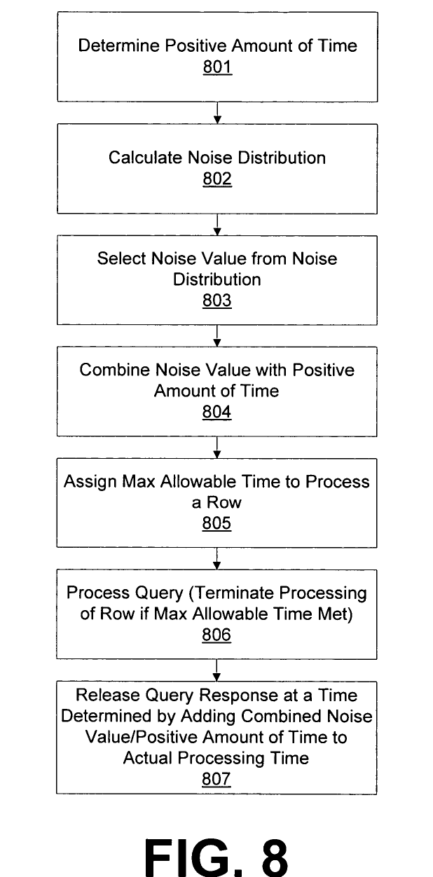

FIG. 8 illustrates an application of the invention to an exemplary scenario in which the resource is time, the item is a database query, and the sub-parts are rows of a database. This example has been referred to throughout this document and so the steps illustrated in FIG. 8 should be familiar. First, some positive amount of time may be determined 801. Next, a noise distribution may be determined 802. The noise distribution may be based on an acceptable variability, during a normal processing operation, in time consumption associated with processing a row. The noise distribution may further be based on a privacy parameter. A noise value may be selected from the noise distribution 803, and combined with the positive amount of time 804. A max allowable amount of time to process any individual row may be assigned 805, and the query may be processed 806. Finally, the query response may be released at a time determined by adding the first noisy quantity to the actual processing time 807.

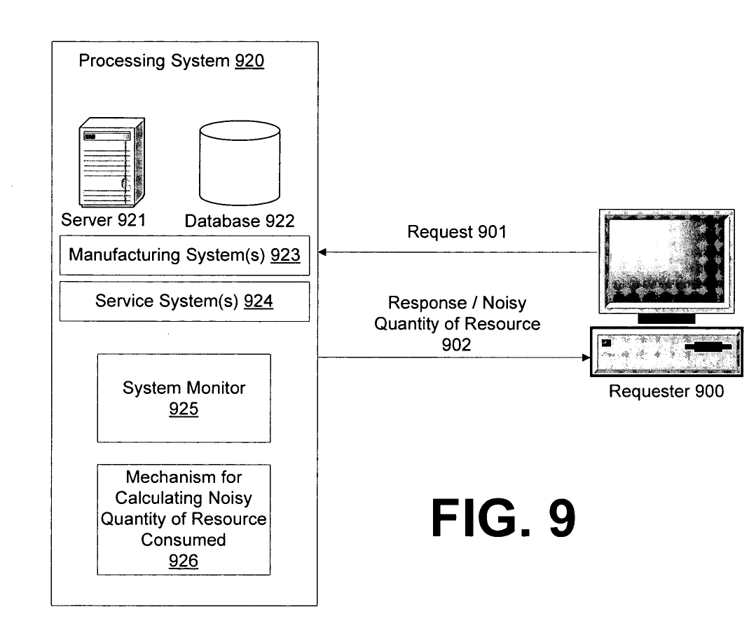

FIG. 9 illustrates an exemplary system 920 that obscures an amount of a resource used to process an item. The system 920 comprises a system monitor 925 that ensures a maximum allowable amount of the resource is not exceeded when processing a sub-part of the item. It also comprises a mechanism 926 for calculating a noisy quantity of the resource that was consumed in processing the item, wherein said quantity is determined by adding a positive amount of the resource combined with a noise value to an actual quantity of the resource that was consumed.

The actual processing in system 920 may be carried out by any of a plurality of subsystems, such as a database 922, a server 921, a manufacturing system 923, or a service system 924. The processing by system 920 may be conducted to satisfy a request 901 sent by a requester 900, in which case the response to the request 902 reveals the noisy quantity of the resource and not the actual quantity of the resource that was consumed by the system 920 to satisfy the request 901. In the arrangement where the processing is conducted to satisfy a request, requester 900 is also a possible adversary, and in any event may communicate information learned to the world outside of system 920, and therefore it may be advantageous to release only noisy information to the requester 900.

The various systems and methods discussed herein may, in some embodiments, be carried out by one or more computing devices which are, in general, well understood. A computing device typically includes at least some form of computer readable media. Computer readable media can be any available media that can be accessed by the device. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by a device. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

In addition to the specific implementations explicitly set forth herein, other aspects and implementations will be apparent to those skilled in the art from consideration of the specification disclosed herein. It is intended that the specification and illustrated implementations be considered as examples only, with a true scope and spirit of the following claims.

1. A method for obscuring an amount of time used to process a query, comprising:
assigning a maximum allowable time for processing a row;
releasing a query response at a time that is determined by adding a positive amount of time combined with a noise value to a total processing time.

2. The method of claim 1, wherein the noise value is a positive noise value.

3. The method of claim 1, wherein the noise value is a negative noise value.

4. The method of claim 1, wherein the positive amount of time is determined at least in part by evaluating a number of rows to which a query is directed.

5. The method of claim 1, wherein the positive amount of time is determined independently of the data in the row.

6. The method of claim 1, wherein if said maximum allowable time is met when processing a row, then processing said row is terminated.

7. The method of claim 1, wherein the noise value is selected from an exponential distribution.

8. The method of claim 1, wherein the total processing time is the actual amount of time used to process the query on all rows to which the query is directed.

9. The method of claim 1, wherein said method is carried out in a database comprising data associated with a plurality of privacy principals.

10. The method of claim 1, wherein the row comprises a password that is used to access a computing resource.

11. A method for obscuring an amount of a resource used to process an item, comprising:
assigning a allowable amount of the resource for processing a sub-part of the item;
releasing a noisy quantity of the resource that was consumed in processing the item, wherein said noisy quantity is determined by adding a positive amount of the resource combined with a noise value to an actual quantity of the resource that was consumed.

12. The method of claim 11, wherein the resource is time.

13. The method of claim 11, wherein the resource is electrical energy.

14. The method of claim 11, wherein the item is a database query, and the sub-part of the item is a row in a database.

15. The method of claim 11, wherein the positive amount of the resource is determined at least in part by evaluating a number of sub-parts of the item that were processed.

16. The method of claim 11, wherein the noise value is selected from an exponential distribution.

17. A system that obscures an amount of a resource used to process an item, comprising:
a system monitor that ensures a maximum allowable amount of the resource is not exceeded when processing a sub-part of the item;
a mechanism for calculating a noisy quantity of the resource that was consumed in processing the item, wherein said quantity is determined by adding a positive amount of the resource combined with a noise value to an actual quantity of the resource that was consumed.

18. The system of claim 17, wherein the resource is time.

19. The system of claim 17, wherein the resource is electrical energy.

20. The system of claim 17, wherein the noise value is selected from an exponential distribution.
